(19) United States
(12) Patent Application Publication
(10) Pub. No.: US 2021/0097491 A1
(43) Pub. Date: Apr. 1, 2021

(54) METHOD AND APPARATUS FOR PROVIDING MANAGEMENT OF DEAL-AGREEMENTS EMBEDDED IN E-COMMERCE CONVERSATIONS

(71) Applicant: Honeywell International Inc., Morris Plains, NJ (US)

(72) Inventors: Jason Minyard, Phoenix, AZ (US); Kevin Suits, Phoenix, AZ (US); Matthew Solis, Scottsdale, AZ (US)

(21) Appl. No.: 16/588,944

(22) Filed: Sep. 30, 2019

(51) Int. Cl. G06Q 10/10; G06F 17/27; G06Q 30/02; G06N 20/00

(52) U.S. Cl. CPC G06Q 10/107; G06N 20/00; G06Q 30/0201; G06F 17/2785

(57) ABSTRACT

Various embodiments enable generation of a document specifically customized to electronic commerce based messaging communications. The document is provided by a transaction documentation system which receives a communication stream comprising a plurality of messages shared via a marketplace platform. The system then analyzes the plurality of messages of the communication stream to identify data elements corresponding to one or more fillable fields of the document. The one or more fillable fields of the document is populated with data elements identified within the one or more messages of the communication stream.

### BACKGROUND

Buyer/seller interactions often occur through a number of different communication channels, often starting with a product listing or a wanted ad on a seller marketplace, before moving to a more direct communication channel, such as emails, text messages, phone calls and/or the like. However, some of these communication channels are characterized by a certain amount of anonymity, and so buyers and sellers are not immediately able to distinguish between legitimate buy/sell opportunities and phishing attempts. Moreover, as communications span multiple communication channels, and because buyers and sellers often are involved in a number of transactions at any given time, those buyers and sellers can easily forget aspects of a particular transaction that have already been determined.

Various electronic marketplace platforms exist. However, improvements may yet be desired for tracking and analyzing electronic marketplace communications to identify transaction intent to purchase and/or sell a product and/or service. Further, the amount of communication messages may be overwhelming to a buyer/seller. Furthermore, important content in the communication messages may generally get ignored, overlooked, forgotten, or otherwise ineffectively conveyed to a user. There is, therefore, a need for systems and methods that facilitate the identification of important messages for a user with respect to ongoing or prospective transactions. Through applied effort, ingenuity, and innovation, many of these identified problems have been solved by developing solutions that are included in embodiments of the present invention, many examples of which are described in detail herein.

### BRIEF SUMMARY

In general, embodiments of the present invention provide methods, apparatus, systems, computing devices, computing entities, and/or the like for generation of a document specifically customized to electronic commerce based messaging communications. Certain embodiments are specifically configured for identifying a predicted transaction intent to purchase and/or sell a product and/or service in buyer and seller conversations.

In accordance with one aspect, a method is provided. In one embodiment, the method comprises receiving a communication stream comprising a plurality of messages shared via a marketplace platform, analyzing the plurality of messages of the communication stream to detect a transaction intent, retrieving a document based at least in part on the detected transaction intent, wherein the document comprises one or more fillable fields tagged with a required data element, identifying, within one or more messages of the communication stream, data elements corresponding to the one or more fillable fields of the document, populating the one or more fillable fields of the document with data elements identified within the one or more messages of the communication stream, and storing the document comprising or more populated fillable fields in association with the communication stream in at least one data structure.

In accordance with another aspect, a computer program product is provided. The computer program product may comprise at least one computer-readable storage medium having computer-readable program code portions stored therein, the computer-readable program code portions comprising executable portions configured to receive a communication stream comprising a plurality of messages shared via a marketplace platform, analyze the plurality of messages of the communication stream to detect a transaction intent, retrieve a document based at least in part on the detected transaction intent, wherein the document comprises one or more fillable fields tagged with a required data element, identify, within one or more messages of the communication stream, data elements corresponding to the one or more fillable fields of the document, populate the one or more fillable fields of the document with data elements identified within the one or more messages of the communication stream, and store the document comprising or more populated fillable fields in association with the communication stream in at least one data structure.

In accordance with yet another aspect, an apparatus comprising at least one processor and at least one memory including computer program code is provided. In one embodiment, the at least one memory and the computer program code may be configured to, with the processor, cause the apparatus to receive a communication stream comprising a plurality of messages shared via a marketplace platform, analyze the plurality of messages of the communication stream to detect a transaction intent, retrieve a document based at least in part on the detected transaction intent, wherein the document comprises one or more fillable fields tagged with a required data element, identify, within one or more messages of the communication stream, data elements corresponding to the one or more fillable fields of the document, populate the one or more fillable fields of the document with data elements identified within the one or more messages of the communication stream, and store the document comprising or more populated fillable fields in association with the communication stream in at least one data structure.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is an exemplary overview of a system in accordance with various embodiments;

FIG. 2 illustrates an example server device in accordance with some embodiments discussed herein;

FIG. 3 illustrates an example client device in accordance with some embodiments discussed herein;

FIG. 4 illustrates a flow diagram of an example system in accordance with some embodiments discussed herein;

FIGS. 5, 6A, 6B, and 7 illustrate example computer interfaces of a system structured in accordance with various embodiments discussed herein; and

FIG. 8 illustrates an example process of an example system in accordance with some embodiments discussed herein.

### DETAILED DESCRIPTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

### I. Overview

Discussed herein are methods, apparatuses, systems, computing devices, computing entities, and/or the like that are configured to aid buyers and sellers in electronic-based transaction conversations to identify important information conveyed via an electronic communication regarding an ongoing or prospective transaction. Certain embodiments are specifically configured for identifying a predicted transaction intent to purchase and/or sell a product and/or service in buyer and seller conversations. In one or more implementations, an event (communication) is received and electronic commerce-based messaging communications that are related to the event and entity are collected. Then, transaction intent data indicative of a user's (e.g., a buyer or seller) intentions to enter a transaction are generated using regular expression (RegEx) scripts based at least in part on the collected data. In one or more implementations a transaction intent model, usable to identify events/communications expressing or otherwise indicative of transaction intent, is built from a training corpus of metadata-tagged messaging communications using a classification system. In an example embodiment, the system generates a dynamically modifiable electronic transaction document having fields populated with data retrieved from messages exchanged via a messaging system and based at least in part on metadata tags assigned to those messages. As will be recognized, however, the disclosed concepts can be used to provide suggested conversational messages that may be important and/or relevant to the user and are not limited to a particular context.

For certain electronic commerce marketplace platforms, there is a large number of buyer and seller conversational messages exchanged on the electronic commerce marketplace platforms at any given time. For example, buyers and sellers may begin discussions regarding a potential transaction via a communication system of an online commerce marketplace platform to exchange information about what the parties are offering for sale and/or what the parties are looking to purchase. For instance, a buyer may say “I'm hoping you can send me a quote for a widget for an exchange place cost. Looking to get the unit by Jul. 25, 2019.”, which means that the buyer wants a quote for an item (the widget) with a requested ship date. Being able to track buyer and seller conversations is very valuable to sellers because if a seller knows what a buyer needs, the seller can effectively target a potential buyer and quickly assess whether a purchase agreement can be made. Such tracking may also be valuable to a buyer as well, as the buyer can quickly check quotes, quantities, specifications, and/or the like conveyed by the seller for accuracy and compliance with requested transaction parameters.

In an example embodiment, methods described herein are configured to provide a special purpose computing system to provide techniques for identifying purchase intent to purchase and/or sell a product and/or service in buyer and seller conversations, ensuring the most important and/or relevant conversational messages are prioritized for consumption in an interface, such as by providing scoring, data analytics, and/or machine-learning to provide a predicted likelihood a user will enter a transaction/agree to a transaction agreement deal, such as forecasting/predicting transaction intent for a user/buyer/seller. In an example embodiment, the systems and methods described herein are configured to provide analytics for generating an output to a modifiable electronic transaction agreement generated from a training corpus of metadata-tagged messaging communications using a classification system. The generated transaction agreement may be provided to the buyer/seller via a graphical user interface accessible via one or more computing entities.

In some examples, the systems and methods described herein may collect, ingest, or otherwise access a communication stream comprising a plurality of messages shared via an electronic marketplace platform. In some examples, the systems and methods are configured to evaluate the communication stream based at least in part on generated metadata indicative of forecast/predicted purchase intent using RegEx scripts and/or to provide analysis/forecasting of purchase intent for the buyer/seller. Moreover, certain embodiments are configured to automatically generate a modifiable electronic transaction document accessible to the buyer/seller (e.g., via a personalized graphical user interface dashboard accessible to the buyer/seller) based on the contents of one or more messages exchanged between the buyer and seller. The automatically generated modifiable electronic transaction agreement may be updated automatically, as the buyer and seller exchange additional messages that may provide further detail regarding aspects of the proposed transaction. Accordingly, the provision of a modifiable electronic transaction agreement, and the most important and/or relevant conversational messages and data are prioritized and/or classified for consumption in a personalized graphical user interface.

Accordingly, various embodiments provide a technological improvement that results in minimizing the amount of data consumed and transmitted to and from devices and computing entities within a marketplace platform, while also ensuring the most important and/or relevant conversational messages and data are identified and prioritized for consumption in an interface. In certain embodiments, one or more modifiable electronic transaction agreement documents may be generated via a transaction documentation system operable in association with a marketplace platform and specifically customized to electronic commerce based messaging communications expressing transaction intent. Additionally, when downloading the modifiable electronic transaction agreement documents, over, for example, a restricted bandwidth network, download times can be minimal due to the reduced volume of data. Thus, the transaction documentation system of the present disclosure provides savings in memory, transmission/network bandwidth, processing power, and time.

### II. Computer Program Products, Methods, and Computing Entities

Embodiments of the present invention may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### III. Exemplary System Architecture

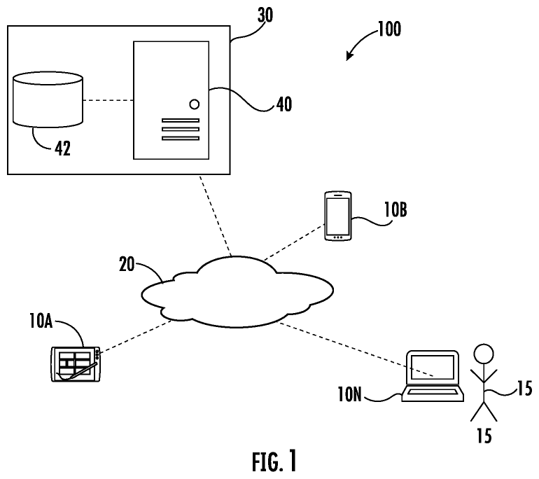

FIG. 1 provides an illustration of an exemplary embodiment of the present invention. FIG. 1 shows system 100 including an example network architecture for a system, which may include one or more devices and sub-systems that are configured to implement embodiments discussed herein. For example, the system 100 may include marketplace platform 30 which can include transaction documentation system 40 and at least one database 42. The marketplace platform 30 may facilitate the transactions, sales and/or exchanges of products or services between users, buyers, sellers, dealers, and the like. Transaction documentation system 40 can include, for example, processing resources, a data storage area (e.g., a database), and/or the like. The transaction documentation system 40 may include any suitable type of processing device. In some embodiments, the transaction documentation system 40 may determine and transmit commands and instructions for purchase intent models, generate dynamically modifiable electronic purchase agreements using data stored via a at least one database 42 which may be stored as a part of and/or in communication with one or more client devices 10A, 10B-10N and/or the transaction documentation system 40. The at least one database 42 includes information captured and stored by the one or more client devices 10A-10N to facilitate the operations of the system.

System 100 includes the one or more client devices 10A-10N configured for communication with the transaction documentation system 40 via network 20. Users may access a marketplace platform 30 via network 20 using client devices 10A-10N. The marketplace platform 30 may comprise the transaction documentation system 40 that is disposed in communication with at least one at least one database 42. Client devices 10A-10N may be operated by and/or may represent a variety of entities, including buyers, sellers, organizations such as aviation institutes, maintenance professionals, other individuals, other organizations, and/or the like. It should be understood that the system 100 may implement an industry-specific marketplace (e.g., aviation repair) for the exchange of items/services between industry professionals. As other examples, the system 100 may implement cross-industry, industry-agnostic, or entirely open marketplaces for the exchange of items/services between users.

In one embodiment, transaction documentation system 40 may represent a set of servers or clusters of servers associated with a service provider and geographically distributed over a network. For example, transaction documentation system 40 may be associated with an electronic commerce marketplace platform. Network 20 may be a local area network (LAN), a metropolitan area network (MAN), a wide area network (WAN) such as the Internet or an intranet, or a combination thereof. Transaction documentation system 40 may comprise a variety of servers and devices capable of providing application services to a variety of clients such as client devices 10A-10N over network 20. In one embodiment, transaction documentation system 40 includes one or more classification systems to provide data processing services, one or more databases 42 to store user data, dynamically modifiable electronic purchase agreements, and other transaction data, and one or more routers to transfer data to/from other entities such as entities client devices 10A-10N.

With reference again to FIG. 1, at least one database 42 may be a data store to store user transaction data and/or generated outputs (e.g., dynamically modifiable electronic purchase agreements, transaction intent models, etc.). In certain embodiments, at least one database 42 may also incorporate encryption capabilities. At least one database 42 may include multiple databases and/or may be maintained by a third party vendor such as a storage provider. In an example embodiment, at least one database 42 comprises information accessed and stored by the transaction documentation system 40 to facilitate the operations of the marketplace platform 30. For example, the at least one database 42 may include, without limitation, communication messaging data, user data, and transaction data.

In some embodiments, the transaction documentation system 40 is configured to provide electronic commerce based messaging communications data processing services to client devices 10A-10N operated by buyers/sellers 15 and/or the like. The transaction documentation system 40 of certain embodiments, also referred to as a transaction documentation monitoring and processing server, is configured to, for example, identify forecast/predicted transaction (sale/purchase) intent in buyer and seller conversations, manage the conversations, classify and prioritize the conversations, and generate documents based on the conversations. In yet another example embodiment, the transaction documentation system 40 is configured to update and manage the documents such that buyers/sellers are presented with the most updated transaction agreement data elements, thereby ensuring the most important potential transaction deals are prioritized (e.g., visually prioritized) for consumption in an interface.

Transaction documentation system 40 is configured to communicate with one or more client devices 10A-10N and/or other computing entities via network 20, and a plurality of client devices 10A-10N may communicate with one another and/or with other computing entities via the network 20. In this regard, network 20 may include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, etc.). For example, network 20 may include a cellular telephone, an 802.11, 802.16, 802.20, and/or WiMax network. Further, the network 20 may include a public network, such as the Internet, a private network, such as an intranet, or combinations thereof, and may utilize a variety of networking protocols now available or later developed including, but not limited to TCP/IP based networking protocols.

Client devices 10A-10N and/or transaction documentation system 40 may be implemented as and/or may comprise one or more computers, computing entities, desktop computers, mobile phones, tablets, phablets, notebooks, laptops, distributed systems, items/devices, input terminals, servers or server networks, blades, gateways, switches, processing devices, processing entities, set-top boxes, the like, and/or any combination of devices or entities adapted to perform the functions, operations, and/or processes described herein. The depiction in FIG. 1 of “N” client devices is merely for illustration purposes. Any number of users and/or client devices 10 may be included in the system for accessing and/or implementing aspects of the transaction documentation system 40 discussed herein (e.g., via one or more interfaces). In one embodiment, the client devices 10A-10N may be configured to display or provide a transaction update interface on a display of the client device for viewing, creating, editing, and/or otherwise interacting with one or more dynamically modifiable electronic purchase agreements, which may be provided or pushed by the transaction documentation system 40 (and may be stored locally at one or more client devices 10A-10N and/or transaction documentation system 40). According to some embodiments, the transaction documentation system 40 may be configured to cause display or presentation of an interface for viewing, creating, editing, and/or otherwise interacting with one or more transaction updates.

As indicated above, the client devices 10A-10N may be any computing device as defined above. Electronic data received by the transaction documentation system 40 from the client devices 10A-10N may be provided in various forms and via various methods. For example, the client devices 10A-10N may include desktop computers, laptop computers, smartphones, netbooks, tablet computers, and the like. In embodiments where a client device 10A-10N is a mobile device, such as a smart phone or tablet, the client device 10A-10N may execute an “app” such as the transaction documentation application in association with the marketplace platform 30 to interact with the transaction documentation system 40. Such apps are typically designed to execute on mobile devices, such as tablets or smartphones. For example, an app may be provided that executes on mobile device operating systems such as iOS®, Android®, or Windows®. These platforms typically provide frameworks that allow apps to communicate with one another and with particular hardware and software components of mobile devices. For example, the mobile operating systems named above each provide frameworks for interacting with location services circuitry, wired and wireless network interfaces 320, user contacts, and other applications. Communication with hardware and software modules executing outside of the app is typically provided via application programming interfaces (APIs) provided by the mobile device operating system.

Additionally or alternatively, the client device 10A-10N may interact with the transaction documentation system 40 in association with the marketplace platform 30 via a web browser. As yet another example, the client device 10A-10N may include various hardware or firmware designed to interface with the transaction documentation system 40 in association with the marketplace platform 30.

A. Exemplary Transaction Documentation System

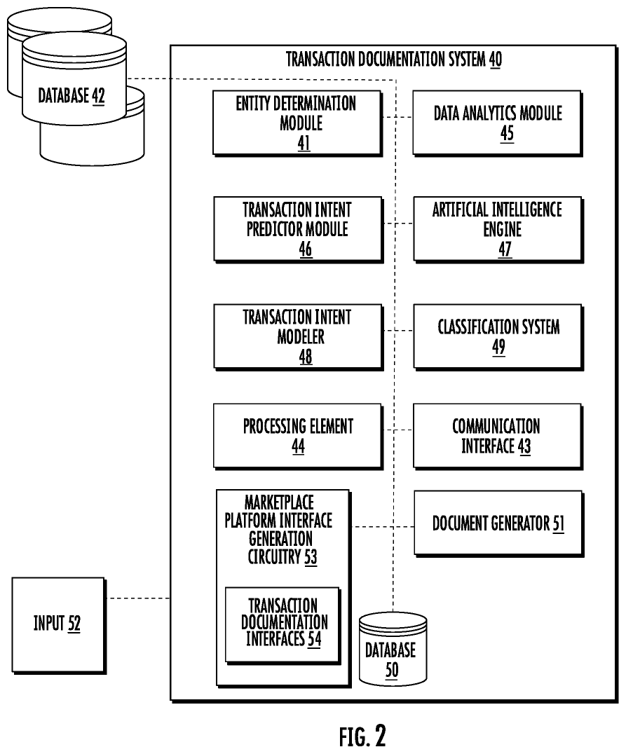

FIG. 2 provides a schematic of a transaction documentation system 40 according to one embodiment of the present invention. In general, the terms computing entity, entity, device, system, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

Although illustrated as a single computing entity, it should be understood that the transaction documentation system 40 may be embodied as a plurality of computing entities, tools, and/or the like operating collectively to perform one or more processes, methods, and/or steps. As just one non-limiting example, the transaction documentation system 40 may comprise a plurality of individual data tools, such as an entity determination module 41, communication interface 43, processing element 44, data analytics module 45, transaction intent predictor module 46, artificial intelligence engine 47, transaction intent modeler 48, classification system 49, database 50, document generator 51, marketplace platform interface generation circuitry 53, and/or the like. Each of these tools may perform specified tasks and/or processes, such that collectively, the transaction documentation system 40 may be configured to execute one or more tasks requested by a user.

As indicated, in one embodiment, the transaction documentation system 40 may include one or more network and/or communication interface 43 for communicating with various computing entities, such as by communicating data, content, information, and/or similar terms used herein interchangeably that can be transmitted, received, operated on, processed, displayed, stored, and/or the like. For instance, the transaction documentation system 40 may communicate with other computing entities, one or more client devices 10A-10N and/or the like. In certain embodiments, the transaction documentation system 40 may be configured to receive data from one or more data sources, such as receiving user data from a marketplace platform 30 in association with the transaction documentation system 40 and/or receiving data indicative of analysis performed by one or more modules of the transaction documentation system 40 via database 50, and the transaction documentation system 40 may be configured to receive data indicative of user input 52, for example, from a client device 10A-10N.

The marketplace platform interface generation circuitry 53 is configured to provide a marketplace platform interface having transaction documentation interfaces 54. The marketplace platform interface generation circuitry 53 is configured to facilitate user interaction with marketplace platform 30. The transaction documentation interfaces 54 are accessible and viewable to marketplace platform users and comprises assembled renderings of transaction documents and categorized communication streams to facilitate the transactions, sales and/or exchanges of products or services between users. In one example, the transaction documentation interfaces 54 may provide a user of a client device a view of potential transaction deals of high priority (e.g. communication messages forecasted/predicted to have purchase intent).

As shown in FIG. 2, in one embodiment, the transaction documentation system 40 may include or be in communication with one or more processing element 44 (also referred to as processors, processing circuitry, and/or similar terms used herein interchangeably) that communicate with other elements within the transaction documentation system 40 via a bus, for example, or network connection. As will be understood, the processing element 44 may be embodied in a number of different ways. For example, the processing element 44 may be embodied as one or more complex programmable logic devices (CPLDs), microprocessors, multi-core processors, coprocessing entities, application-specific instruction-set processors (ASIPs), and/or controllers. Further, the processing element 44 may be embodied as one or more other processing devices or circuitry. The term circuitry may refer to an entirely hardware embodiment or a combination of hardware and computer program products. Thus, the processing element 44 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 44 may be configured for a particular use or configured to execute instructions stored in volatile or non-volatile media or otherwise accessible to the processing element 44. As such, whether configured by hardware or computer program products, or by a combination thereof, the processing element 44 may be capable of performing steps or operations according to embodiments of the present invention when configured accordingly.

In one embodiment, the transaction documentation system 40 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media, which may be implemented as a database 50 and/or may be embodied as hard disks, ROM, PROM, EPROM, EEPROM, flash memory, MMCs, SD memory cards, Memory Sticks, CBRAM, PRAM, FeRAM, RRAM, SONOS, racetrack memory, and/or the like. As will be recognized, the non-volatile storage or memory media may store databases, database instances, database management system entities, data, applications, programs, program modules, scripts, source code, object code, byte code, compiled code, interpreted code, machine code, executable instructions, and/or the like. The term database, database instance, database management system entity, and/or similar terms used herein interchangeably and in a general sense to refer to a structured or unstructured collection of information/data that is stored in a computer-readable storage medium.

Memory media may also be embodied as a data storage device or devices, as a separate database server or servers, or as a combination of data storage devices and separate database servers. Further, in some embodiments, memory media may be embodied as a distributed repository such that some of the stored information/data is stored centrally in a location within the system and other information/data is stored in one or more remote locations. Alternatively, in some embodiments, the distributed repository may be distributed over a plurality of remote storage locations only. An example of the embodiments contemplated herein would include a cloud-based data storage system maintained by a third party provider and where some or all of the information/data.

In one embodiment, the transaction documentation system 40 may further include or be in communication with volatile media (also referred to as volatile storage, memory, memory storage, memory circuitry and/or similar terms used herein interchangeably). In one embodiment, the volatile storage or memory may also include one or more volatile storage or memory media as described above, such as RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. As will be recognized, the volatile storage or memory media may be used to store at least portions of the databases, database instances, database management system entities, data, applications, programs, program modules, scripts, source code, object code, byte code, compiled code, interpreted code, machine code, executable instructions, and/or the like being executed by, for example, the processing element 44. Thus, the databases, database instances, database management system entities, data, applications, programs, program modules, scripts, source code, object code, byte code, compiled code, interpreted code, machine code, executable instructions, and/or the like may be used to control certain aspects of the operation of the transaction documentation system 40 with the assistance of the processing element 44 and operating system.

As indicated, in one embodiment, the transaction documentation system 40 may also include one or more network and/or communication interface 43 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the transaction documentation system 40 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The transaction documentation system 40 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

As will be appreciated, one or more of the transaction documentation system's 40 components may be located remotely from the transaction documentation system 40 components, such as in a distributed system. Furthermore, one or more of the components may be aggregated and additional components performing functions described herein may be included in the transaction documentation system 40. Thus, the transaction documentation system 40 can be adapted to accommodate a variety of needs and circumstances.

The entity determination module 41, communication interface 43, processing element 44, data analytics module 45, transaction intent predictor module 46, artificial intelligence engine 47, transaction intent modeler 48, classification system 49, document generator 51, and marketplace platform interface generation circuitry 53 make take the form of, for example, a code module, a component, circuitry or the like. The components of the transaction documentation system 40 are configured to provide various logic (e.g. code, instructions, functions, routines and/or the like) and/or services related to the generation one or more dynamically modifiable electronic purchase agreements.

In some example embodiments, the entity determination module 41 is configured to receive user/entity data, such as user data, user context data, user account data or user profile data contained in at least one database 42. User data, user context data, user account data or user profile data, in some embodiments, may include user identifier data, contact information data, transaction history data, biographical profile data, data related to interactions with other users/entities, authorization status data, and/or preference data associated with individual users, groups of users, or a company. The user account data and/or user profile data for a particular user may be generated and/or stored upon a user registering for use of the entity determination module 41 and/or marketplace platform. The receipt or input of the user data may occur in response to an event (e.g. a communication), a user input, a user request, or the like. For example, the user data may be input if a communication is received suggesting a desire to purchase a product. In other examples, the user data may be input in response to an input or request, such as a request for details relating to the user. Alternatively or additionally the entity determination module 41 may be configured to receive or input user data continuously or semi-continuously, such as via a data stream, and determine a transaction intent of the user data.

A data analytics module 45 may be configured to input the user data contained in at least one database 42 and determine a forecast/predicted transaction intent and/or relationships relating to one or more communications (e.g., messages) transmitted by a user via the electronic marketplace platform. In order to determine the forecast/predicted transaction intent and relationships, the data analytics module 45 may access the at least one database 42 directly or indirectly via the entity determination module 41 or the like. The at least one database 42 may contain information related to the particular user. For instance, at least one database 42 may provide data insights related to purchase intent behaviors (e.g., language utilized by the user to initiate transaction inquiries that ultimately became consummated transactions; language utilized by the user to initiate transaction inquiries that did not ultimately become consummated transactions; the overall percentage of transaction inquiries initiated by the user that became consummated transactions; and/or the like), information related to anomalous behaviors by the user, and/or the like. In other examples, at least one database 42 may describe relationships between various events and/or phenomena in data. For example, at least one database 42 may indicate for a particular user that the user has no prior purchasing history, which may indicate that messages generated/transmitted by the user are spam. Said users may be labeled as blacklisted, whereas users with a purchase history may be marked as important or having priority. In some example embodiments, each of the relationships between various events and/or phenomena in the data may be assigned an importance value/ranking and/or otherwise may be weighted based on the priority level of the relationship between the various events, communications, and/or phenomena in the data.

Embodiments of the present disclosure provide for obtaining or otherwise ingesting transaction intent models from database 50 via for example, transaction intent modeler 48. In some examples, the transaction intent models may take the form of a data model that defines or otherwise described how data is connected, related, or should otherwise be processed. In further examples, a data model may be a hierarchical/tree knowledge representation that includes rules that are a combination of features and values that characterize the underlying knowledge or data. As described herein, the transaction intent model may include or may otherwise be suggestive as to a transaction intent.

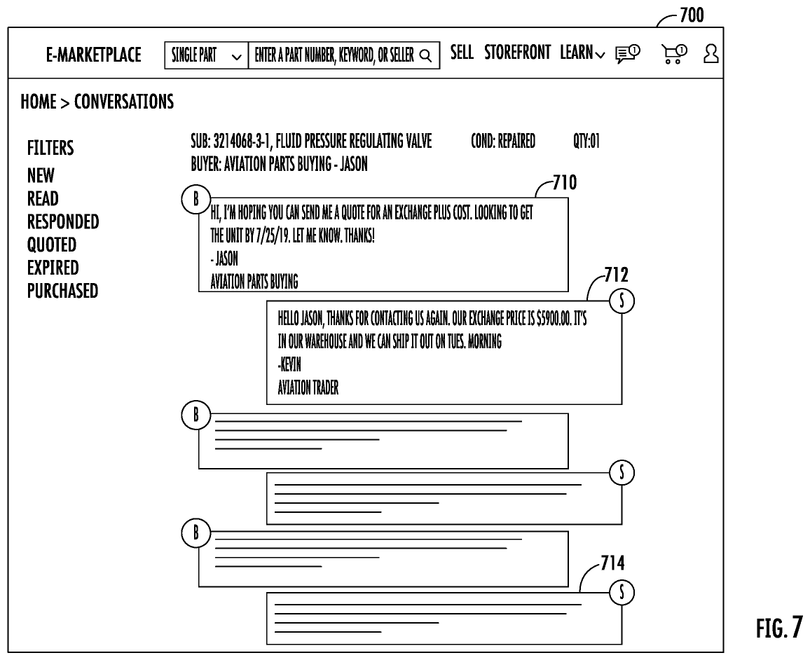

In one example, a communication stream representing a set of information data as depicted in FIG. 7. FIG. 7 illustrates, for example, a user interface 700 displaying a communication stream between a buyer and seller having data related to a potential transaction. For example, the illustrated user interface 700 provides data from the perspective of the seller, and includes data showing the object/part for which the communication relates (specifically “3214068-3-1, Fluid Pressure Regulating Valve”), the condition of the object/part (“COND: Repaired”), the name of the buyer on the opposite side of the transaction (“Aviation Parts Buying—Jason”), and the quantity (“01”). It should be understood that additional data may be provided via the user interface 700 in certain embodiments. Specifically, FIG. 7 illustrates a communication 710 from the buyer (“Jason” in the illustrated example) requesting “a quote for an exchange plus cost” by Jul. 25, 2019. A communication 712 from the seller (“Kevin” in the illustrated example) in response to the communication 710 was transmitted indicating an exchange price of $5900 with a ship data as early as Tuesday morning. Additional communications are exchanged (as illustrated by the placeholder conversation bubbles in the illustrated example) while the deal is negotiated until an agreement is reached and a request to prepare a formal quote as shown in communication 714.

However, the details of the agreed upon deal are now embedded in communications 710, 712, and 714 in an unstructured format. Accordingly, and in examples not having the methods and systems described herein, a communication stream negotiating a deal having deal agreement details would require significant effort to manage from the buyer/seller perspective.

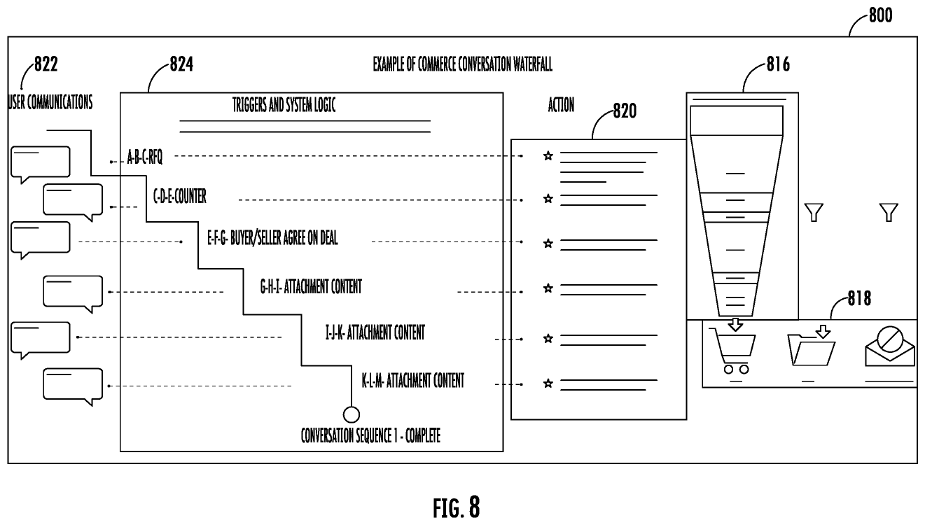

Accordingly, the illustrated process 800 of FIG. 8 provides a model for determining a predicted/forecast transaction intent and extracting details of the deal to prepare and generate one or more dynamically modifiable electronic transaction documents (e.g., a formal quote, a sale agreement, an invoice, and/or the like). The example process 800 may be embodied via the artificial intelligence engine 47 and the classification system 49 to enable classification of the transaction intent to purchase and/or sell a product and/or service of communication stream 822 and generation of a dynamically modifiable electronic transaction document (or other transaction document, as requested/required by one or more users) based on a training corpus of metadata-tagged messaging communications derived from transaction intent modeler 48. That is, in some examples, the classification system 49 may be configured to identify a transaction intent, extract data expressing transaction intent identified using natural language processing (NLP) scripts, such as regular expression (RegEx) scripts in preparation to generate the dynamically modifiable electronic transaction document with data extracted from one or more messages exchanged within a communication stream based at least in part on metadata tags assigned to the one or more messages (or words/text within the one or more messages).

In some examples, the one or more communication stream 822 may be marked as significant communications based on the example process 800. For example, communications that have data matching keywords indicative of moving forward in the transaction deal negotiation lifecycle funnel 816 may be marked as significant and classified accordingly as shown by process steps 824 and 820. These words may be defined universally by the system 100, or the words may be defined (e.g., via artificial intelligence) for individual users so as to reflect the dialect/parlance/word choice typically used by the individual user. The classification system 49 may be configured for classifying the communications with respect to categories relevant to electronic commerce. As one example, the data from the communications may be processed, parsed and/or categorized relative to a taxonomy that is specific to electronic commerce. For instance, data may be recognized as relating to transaction negotiation in-progress, and/or transaction awaiting payment, as similarly described with respect to data classification described herein. In an example embodiment and as shown by 818, classifications may include a first classification where the communications are archived, a second classification where the transaction intent is updated as a transaction in-progress, awaiting agreement, awaiting payment, for example, a third classification where the communications signal for the generation of an electronic transaction document, and a fourth classification where the communications are identified as spam. In certain embodiments, the classifications may be defined by the system, however it should be understood that in certain embodiments, a user may select particular categories to be utilized for the system.

In some examples, the transaction intent models may be created manually or automatically, such as by machine learning and/or data mining algorithms. Furthermore, the transaction intent models comprise a plurality of rules, wherein the plurality of rules are a combination of keywords, features and values that characterize meaningful communications (e.g., communications affecting the estimated likelihood to make a transaction) from the plurality of communications.

In some examples, the transaction intent predictor module 46 is configured to process data from the communication stream 822 by determining a transaction intent classification/level/category for one or more communications, using the artificial intelligence engine 47, by comparing the data associated with each of the communications in the communication stream with received/stored keywords (or other characteristics) indicating particular transaction intent categories. The artificial intelligence engine 47 may identify metadata expressing a particular transaction intent category using NLP scripts, such as RegEx scripts, from the data. For example, FIG. 8 represents the process of drawing information from the communications as input for RegEx scripts for identifying keywords indicative of moving forward in the deal negotiation lifecycle. The communication events are categorized, data from the communications are tagged, and the tagged data/metadata may be used to populate a dynamically modifiable electronic transaction document.

In some example embodiments, the artificial intelligence engine 47 may be configured to determine the transaction intent classifications of one or more detected patterns in the data of the communication stream, such as by using the transaction intent modeler 48. The artificial intelligence engine 47 may assign a transaction intent classification/category/level based on the pattern itself (e.g. rate of communications transmitted), temporal relationships between the pattern in the data and patterns in other related data, keywords within communications sent by a particular user and keywords stored in association with the transaction intent modeler 48 for the user indicating whether the user is likely to continue with the transaction or abandon the transaction, cost data for similar items purchased/sold through the marketplace platform, and/or the like. For example, a cost estimate of less than $1200 may indicate an approved purchase cost based on previous agreed upon transactions with cost estimates below $1200. In some examples, the patterns and/or the RegEx scripts may be defined by the transaction intent model, the user or the like.

In some examples, the data from a communication may be marked as significant based on the transaction intent modeler 48 and classification system 49. For example, data indicating a transaction intent defined by one or more transaction intent models may be marked as significant and tagged. It should be understood that a determination that a particular communication is significant may be based at least in part on a determined category assigned to the message. As discussed herein, data exchanged as a part of one or more tagged communications may be input into the classification system 49 to enable the generation of a dynamically modifiable electronic purchase agreement.

In some example embodiments, the classification system 49 is configured to tag data based on stored rules of the classification system 49. For example, a first rule may define one or more characteristics, words, and/or the like of a communication, and a corresponding first classification to be assigned to communications satisfying the first rule. A second rule may define another set of one or more characteristics, words, and/or the like of a communication, and a corresponding second classification to be assigned to communications satisfying the second rule. In certain embodiments, the classification system 49 may be configured to assign a third classification to any communications not satisfying another defined rule. For example, communications that do not satisfy other defined rules may be classified as insignificant and/or do not indicate transaction intent. As such, these communications may be archived. In addition, the tagged data may be mapped to one or more data fields of the generated purchase agreement document. Furthermore, as discussed herein, the system may be configured to generate a dynamically modifiable electronic transaction document (or other transaction document) encompassing negotiated terms, parameters, and/or data elements derived from the communication stream.

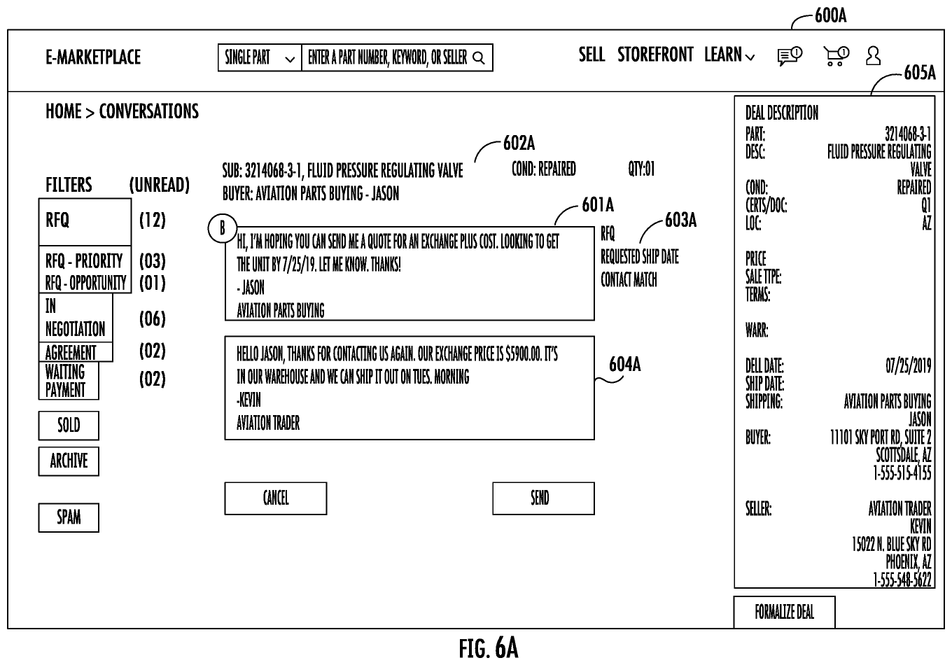

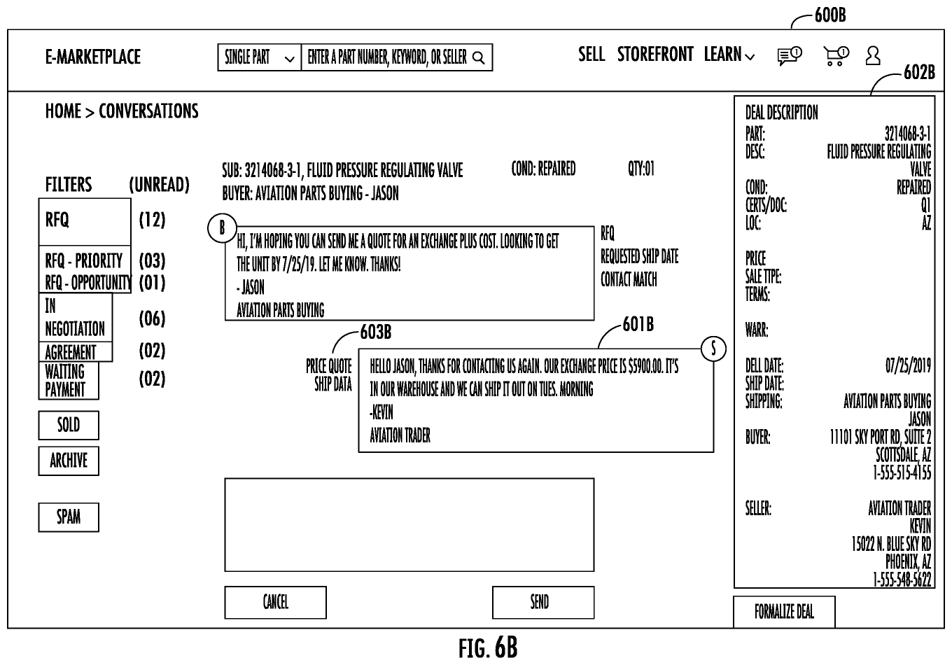

The document generator 51 is configured to receive data from the communication stream and determine how to use the data to populate a transaction document, such as an electronic transaction agreement, an invoice, a quote, and/or the like. In certain embodiments, the document generator 51 may be configured to first determine an appropriate document type, which may be selected from a library of document types and corresponding document templates available to the user. In certain embodiments, the document types (and corresponding document templates) may be user specific (e.g., each of a plurality of users may utilize different document types and/or document templates) or universal. Selecting a particular document type (or multiple document types) for use with a particular communication stream may be performed automatically (e.g., via artificial intelligence) or manually, for example based on receipt of user input selecting one or more document types to be populated for a particular communication stream. The document generator 51 may comprise a content determination process that is configured to select and order the data such that the most up-to-date data is populated in the transaction agreement document. In some examples, the document generator is configured to generate the transaction agreement documents comprising the most up-to-date deal terms for presentation to the user. One example of a visualization of the transaction document is shown with respect to FIGS. 6A and 6B.

B. Exemplary Client Device

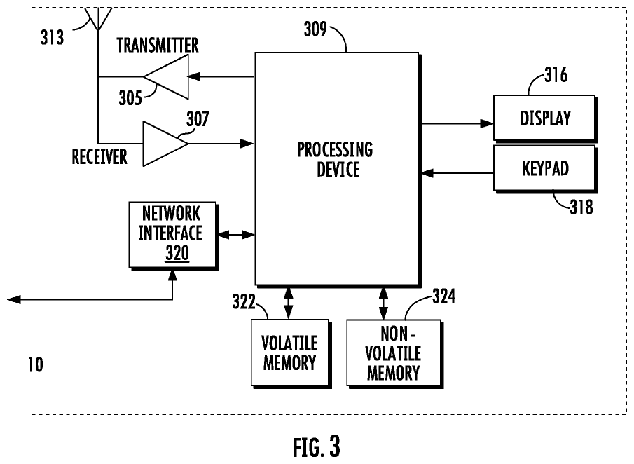

FIG. 3 provides an illustrative schematic representative of client device 10A-10N that can be used in conjunction with embodiments of the present invention. As shown in FIG. 3, a client device 10 can include an antenna 313, a transmitter 305 (e.g., radio), a receiver 307 (e.g., radio), and a processing element 309 that provides signals to and receives signals from the transmitter 305 and receiver 307, respectively. The signals provided to and received from the transmitter 305 and the receiver 307, respectively, may include signaling information/data in accordance with an air interface standard of applicable wireless systems to communicate with various entities, such as a transaction documentation system 40, another client device 10, and/or the like. In this regard, the client device 10 may be capable of operating with one or more air interface standards, communication protocols, modulation types, and access types. More particularly, the client device 10 may operate in accordance with any of a number of wireless communication standards and protocols. In a particular embodiment, the client device 10 may operate in accordance with multiple wireless communication standards and protocols, such as GPRS, UMTS, CDMA2000, 1xRTT, WCDMA, TD-SCDMA, LTE, E-UTRAN, EVDO, HSPA, HSDPA, Wi-Fi, WiMAX, UWB, IR protocols, Bluetooth protocols, USB protocols, and/or any other wireless protocol.

Via these communication standards and protocols, the client device 10 can communicate with various other entities using concepts such as Unstructured Supplementary Service information/data (USSD), Short Message Service (SMS), Multimedia Messaging Service (MIMS), Dual-Tone Multi-Frequency Signaling (DTMF), and/or Subscriber Identity Module Dialer (SIM dialer). The client device 10 can also download changes, add-ons, and updates, for instance, to its firmware, software (e.g., including executable instructions, applications, program modules), and operating system.

According to one embodiment, the client device 10 may include location determining aspects, devices, modules, functionalities, and/or similar words used herein interchangeably. For example, the client device 10 may include outdoor positioning aspects, such as a location module adapted to acquire, for example, latitude, longitude, altitude, geocode, course, direction, heading, speed, UTC, date, and/or various other information/data. In one embodiment, the location module can acquire data, sometimes known as ephemeris data, by identifying the number of satellites in view and the relative positions of those satellites. The satellites may be a variety of different satellites, including LEO satellite systems, DOD satellite systems, the European Union Galileo positioning systems, the Chinese Compass navigation systems, Indian Regional Navigational satellite systems, and/or the like. Alternatively, the location information/data may be determined by triangulating the computing entity's position in connection with a variety of other systems, including cellular towers, Wi-Fi access points, and/or the like. Similarly, the client device 10 may include indoor positioning aspects, such as a location module adapted to acquire, for example, latitude, longitude, altitude, geocode, course, direction, heading, speed, time, date, and/or various other information/data. Some of the indoor aspects may use various position or location technologies including RFID tags, indoor beacons or transmitters, Wi-Fi access points, cellular towers, nearby computing devices (e.g., smartphones, laptops) and/or the like. For instance, such technologies may include iBeacons, Gimbal proximity beacons, BLE transmitters, NFC transmitters, and/or the like. These indoor positioning aspects can be used in a variety of settings to determine the location of someone or something to within inches or centimeters.

The client device 10 may also comprise a user interface device comprising one or more user input/output interfaces (e.g., a display 316 and/or speaker/speaker driver coupled to a processing element 309 and a touch screen, keyboard, mouse, and/or microphone coupled to a processing element 309). For example, the user output interface may be configured to provide an application, browser, user interface, dashboard, webpage, and/or similar words used herein interchangeably executing on and/or accessible via the client device 10 to cause display or audible presentation of information/data and for user interaction therewith via one or more user input interfaces. As just one specific example, the client device 10 may be configured to output various interface screens associated with a marketplace platform, such as product/object search user interfaces, product/object upload user interfaces, communication stream user interfaces (as discussed herein), and/or the like. The user input interface can comprise any of a number of devices allowing the client device 10 to receive data, such as a keypad 318 (hard or soft), a touch display, voice/speech or motion interfaces, scanners, readers, or other input device. In embodiments including a keypad 318, the keypad 318 can include (or cause display of) the conventional numeric (0-9) and related keys (#, *), and other keys used for operating the client device 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the client device 10 can collect information/data, user interaction/input, and/or the like.

The client device 10 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RI IM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the client device 10. Again, as a specific example, the client device memory storage areas (encompassing one or both of the volatile memory 322 and/or non-volatile memory 324) may store the transaction documentation application thereon, which itself may encompass a transaction intent model trained for identifying communication messages expressing transaction intent towards a given product and/or service via one or more machine-learning algorithms.

### IV. Exemplary System Operation

The operation of various embodiments of the present invention will now be described. As discussed herein, various embodiments are directed to systems and methods for determining a forecast/predicted transaction intent in communication messages shared via a marketplace platform. In one or more implementations, a communication stream is received and the plurality of messages to the marketplace platform are analyzed to detect transaction intent. In one or more implementations a transaction intent model, usable to determine a forecast/predicted transaction intent based on identified data elements of the plurality of messages that are indicative of transaction intent, is built from a training corpus of annotated messages and NLP scripts, such as regular expression scripts.

In another example embodiment, a transaction document is received, generated, and/or populated based at least in part on data elements of the plurality of messages within a communication stream. The transaction intent data type may be identified based at least in part on the detected transaction intent, such that an appropriate document may be received and populated automatically based on data elements within the communication stream. The document may comprise one or more fillable fields tagged with required data elements identified within the plurality of messages. The fillable fields may be populated automatically with data elements identified within the plurality of messages automatically, for example, by a computing entity such as the transaction documentation system 40 (e.g., via machine-learning based analysis and/or other automated analysis).

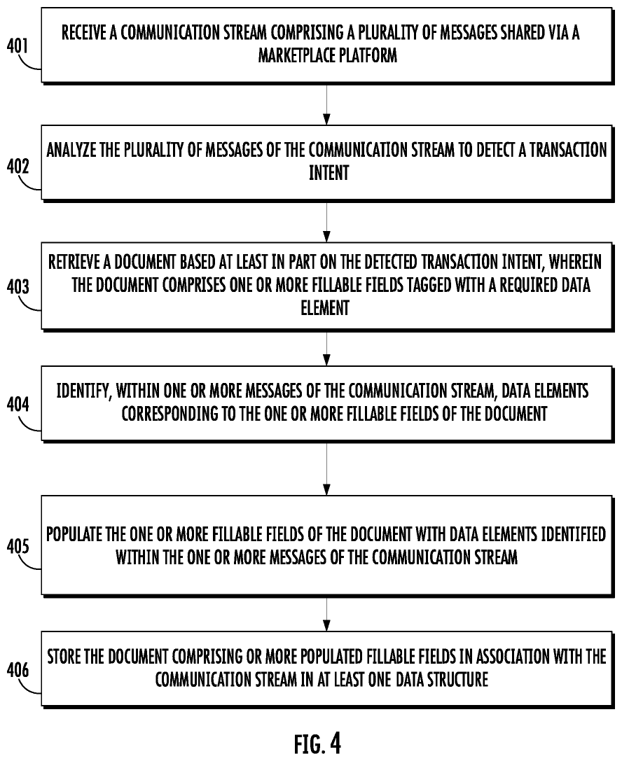

In certain embodiments, the transaction documentation system 40 may be configured to receive a communication stream comprising a plurality of messages shared via a marketplace platform, as reflected at Block 401 of FIG. 4.

As discussed herein, transaction documentation system 40 may be configured to analyze the plurality of messages of the communication stream to detect a transaction intent, as reflected at Block 402. Analyzing the plurality of messages of the communication stream comprises extracting data elements and metadata from one or more messages of the communication stream using NLP scripts, such as regular expression scripts. In another example embodiment, the transaction documentation system 40 may be configured to analyze a training corpus of metadata tagged message communications using the regular expression scripts to identify the data elements indicative of transaction intent and build a transaction intent model by passing the data elements indicative of transaction intent and associated metadata to a machine-learning model. The transaction documentation system 40 may be configured to classify the transaction intent based on the metadata, a context of an entity associated with the communication stream, and the transaction intent model. The context of the entity associated with the communication stream comprises a profile of the entity, a transaction history of the entity with the marketplace platform, and interaction of the entity with other entities in the marketplace platform, and a determined authorization status of the entity.

In Block 403, the transaction documentation system 40 may be configured to retrieve a document based at least in part on the detected transaction intent, wherein the document comprises one or more fillable fields tagged with a required data element.

In certain embodiments, the transaction documentation system 40 may be configured to identify, within one or more messages of the communication stream, data elements corresponding to the one or more fillable fields of the document, as reflected at Block 404.

In Block 405, the transaction documentation system 40 may be configured to populate the one or more fillable fields of the document with data elements identified within the one or more messages of the communication stream. In another example embodiment, the transaction documentation system 40 is further configured to update the one or more fillable fields in response to receiving the communication stream comprising another plurality of messages shared via the marketplace platform.

In Block 406, the transaction documentation system 40 may be configured to store the document comprising or more populated fillable fields in association with the communication stream in at least one data structure.

Upon generation of the document, the transaction documentation system 40 is configured to provide the document to the user/buyer/seller, for example by transmitting the document to a client device (e.g., a client device 10A-10N) associated with the user.

In yet another example embodiment, the transaction documentation system 40 is configured to determine a classification with which to associate the communication stream by utilizing a classification system comprising a first classification, a second classification, and a third classification, archive the communication stream when the communication stream is classified into the first classification, update the transaction intent when the communication stream is classified into the second classification, and generate the document when the communication stream is classified into the third classification.

A. Transaction Intent Determination

Various embodiments of the present disclosure provide a number of technological improvements. For example, by rendering transaction documentation interfaces to a marketplace platform interface. Embodiments of the disclosure avoid burdening device and network resources with frequent simultaneous running of multiple external resource applications for the generation of formal transaction deal agreements. System resources may also be freed-up by providing standardized procedures for the creation and utilization of metadata to improve content searching efficiency.

In some example embodiments, the marketplace platform 30 may be configured for receiving user communication messages associated with a particular product/service via the transaction documentation interfaces of a marketplace platform interface and transmit computer coded instructions for rendering the transaction documentation interfaces comprising formal transaction documents comprising data elements from a plurality of communication messages. In some examples, the marketplace platform interface is configured to facilitate user interaction with a marketplace platform. The marketplace platform may facilitate the sales and/or exchanges of products/services between users. For example, the marketplace platform may facilitate searching for and buying/selling desired products and services. In an example embodiment, the marketplace platform users may enter their preferences in a template, enter their preferences in a search query, and the marketplace platform 30 searches based on the criteria specified, providing a list of products/services matching the specified criteria, as well as suppliers of each product/service appearing in the search results. Users can then select the supplier name and contact them directly to request a quotation, or “RFQ,” using the marketplace platform interface. The marketplace platform in association with the transaction documentation system allows for more efficient control of interactions with users, particularly as it relates to the management and communication of messages.

As described herein, users of a marketplace platform may receive and/or send many messages in a given day, which results in a massive number of communication streams involving the user at any given time. As is typical in any sales-related environment, many of those communications received by users of a marketplace platform may have a low likelihood of maturing into a full, consummated transaction. Accordingly, various systems and methods are configured to distinguish between those communications received by a user that have a high likelihood of maturing into a consummated transaction and those communications received by the user that have a low likelihood of maturing into a consummated transaction. As discussed herein, the likelihood of a communication maturing into a consummated transaction may be expressed—and determined—as a transaction intent reflected by the communication. Determining the transaction intent of a message may comprise determining whether the message comprises words and/or data elements indicating an intent to purchase and/or sell a product or service, determining whether the message or a sender of the message has characteristics associated therewith that indicate that the message indicates a likelihood of maturing into a consummated transaction. In some example embodiments, messages indicating transaction intent include messages comprising data elements in which a user indicates a desire or need for a particular product/service, and/or an intent to purchase/sell the particular product in a period of time. As other non-limiting examples, a message may be determined to indicate a transaction intent based upon a determination that the sender of the message often purchases similar products/services after sending similar messages. Other characteristics may be utilized to determine whether a message indicates a transaction intent. In some example embodiments, messages which do not express transaction intent include messages comprising data elements in which a user expresses negative sentiment towards the particular product/service and/or an intent to not purchase/sell the particular product in a period of time. As another non-limiting example, a message may be determined not to have transaction intent based on a determination that the sending user rarely (or never) purchases products via the marketplace platform.

Determining transaction intent may further include determining a type of transaction intent. With this determined transaction intent data type, the present invention can generate dynamically modifiable transaction documents that include fillable data fields, and thus retrieve documents that best satisfy the transaction intent overall, and customize a transaction document by selectively populating data elements collected from communication messages into the fillable data fields of the dynamically modifiable transaction document. Determining the transaction intent data type includes analyzing the communication message (e.g., by itself, with other messages in a communication stream and/or context regarding the user) or parsing the communication message using a machine learning technique. In an example embodiment, the data analytics module 45 reads the metadata of the communication message, analyzes whether the metadata corresponds to the types of transaction intent data stored in the database 50, and sends information indicative of the corresponding transaction intent data type to document generator 51. For example, if metadata includes “transaction type: ‘sell’”, document generator 51 may identify transaction intent data type “selling” which defines the document type.

In order to determine whether a communication message should be classified as having a transaction intent or not having a transaction intent, a transaction intent model computes a confidence level (e.g., a numerical confidence score) for each of the collected communication messages based at least in part on the data elements of the communication messages. Confidence level is a measure of the confidence of a communication message expressing transaction intent towards a product or service, and is computed based on various data elements and/or characteristics of the communication message. For example, data elements associated with a communication message may comprise metadata such as a sending user identifier (identifying the sender of the message), contact information for the sender, the substantive content (e.g., text) of the message, the time/date stamp of the message, and/or the like. Characteristics associated with a message may be indicative of activities of the sending user, including historical activities of the sender via the marketplace platform. For example, characteristics associated with the message may comprise a quantity of messages sent by the sending user within a defined time period surrounding the time/date stamp of the message, the total quantity of transactions consummated by the user via the marketplace platform, text entered into communications by the sender that ultimately resulted in a consummated transaction, text entered into communications by the sender that ultimately have not resulted in a consummated transaction, and/or the like. In some cases, the confidence level is computed based at least in part on a matching score quantifying how closely a communication message matches a regular expression for identifying transaction intent. Regular expressions are utilized to identify the information-bearing portions of the communication message, and thereby identity the transaction intent. As discussed herein, regular expressions may be stored and utilized universally, across a plurality of users. In other embodiments, regular expressions may be user-specific, so as to indicate phraseology used by the individual user to express a transactional intent.

In certain embodiments, a regular expression is used to identify a transaction intent, whether one or more data elements associated with a communication message matches a legitimate expression of transaction intent. A legitimate expression of transaction intent may, for example, be a collection of known data elements which indicate one or more states of a transaction agreement. These states comprise: 1) initial transaction proposal, 2) under negotiations, 3) acceptance of negotiation, and 4) awaiting final agreement. In an example embodiment, regular expression (RegEx) scripts (or other NLP scripts) are used to describe or match a set of strings, according to certain syntax rules. In this description, RegEx scripts used to search a body of a communication message based on certain text patterns in the body of text of the communication message.

B. Automated Transaction Documentation Generation

Another aspect of the present disclosure is directed to a method for the automatic creation and distribution of a dynamically modifiable transaction document, such as a transaction agreement, a sale agreement, an invoice, a quote, and/or the like. The method for creating the transaction document of certain embodiments comprises detecting a document type for generation, for example, based at least in part on user input and/or based at least in part on the detected transaction intent. Based on the detected appropriate document type, the method may further comprise retrieving a document (e.g., a document template) of the identified document type from a document database; and generating a dynamically modifiable transaction document based at least in part on the retrieved document; distributing for presentation, a representation of the dynamically modifiable transaction agreement document to users associated with the transaction (e.g., associated with a communication string for the transaction); and modifying the dynamically modifiable transaction agreement document, if necessary, to provide a document that is accurate and acceptable to the users. For example, modifying the dynamically modifiable transaction agreement document comprises identifying data elements within one or more communications of the communication string, matching specific identified data elements with tagged portions of the dynamically modifiable transaction agreement document, and filling the identified portions of the dynamically modifiable transaction agreement document with corresponding identified data elements. As communication streams may take multiple rounds of communication to identify all relevant data elements for placement within a transaction document, the method may comprise periodically (e.g., upon transmission of a new communication) determining whether additional portions of the transaction document may be filled with data elements of the communication stream. As new data elements are utilized to fill portions of the transaction document, the representations of the transaction document provided to the users may be updated to reflect the newly identified data elements, and to reflect what additional data elements are necessary to complete the transaction document.

In an example embodiment, the transaction documentation system 40 generates a dynamically modifiable transaction document and stores the dynamically modifiable transaction document in a central repository. The dynamically modifiable transaction documents can be generated by the transaction documentation system 40 using document templates selected from a document template database or can be generated in any other suitable manner. The dynamically modifiable transaction agreement document may be provided in a modifiable format such as Portable Document Format (PDF) and/or a frame of the marketplace platform as shown by FIGS. 6A and 6B.

The transaction documentation system 40 is configured to perform a data population process by converting data elements of the communication messages into form data which conforms to a format required for the dynamically modifiable transaction agreement document identified by the transaction documentation system 40. In an example embodiment, the transaction documentation system 40 is configured to utilize defined rules which are associated or attached to the fillable fields of the document as specified by the transaction documentation system 40. The transaction documentation system 40 applies the rules to the data elements. For example, a rule could check that a data element comprising a date conforms to the date field format of the document, such as Year/Month/Day. It will be appreciated that the above date field format validation rule is just an example of some of preferred validations which could be utilized. A variety of other validation rules will be envisaged by those skilled in the art once taught the invention. New validation rules may be utilized as they are devised. These can be coded as a standalone program and then attached against a field or fields of the document as required.

To obtain proper context for terms in the communication messages, transactional data tagging may be applied to the data elements of the communication messages. For example, transactional data tagging may be used to tag (assign parts of transaction data parameters to) the words in the communication message. As described below, there are a number of approaches to transactional data tagging that may be used in conjunction with natural language processing (NLP) configuration. For example, one type of transactional data tagging performed in connection with NLP includes unigram tagging. Unigram tagging uses a single piece of information (generally a single word/phrase) to decide the most probable tag for association, by lookup in a lexicon. Given a transaction documentation corpus, a lexicon may be created for each word/phrase in the corpus, resulting in words/phrases with a count of the number of times the word or phrase occurs as a particular transactional data in the corpus. For example, “send me a quote” might be tagged over 100 times as a RFQ in the corpus; while words/phrases like “prices is $5900.00” might be tagged as price quote over 100 times. From this information, transaction data parameters (e.g., metadata) may be assigned. Another technique for use with transactional data tagging in NLP involves the use of bigram tagging. For example, rather than just applying the most probable tag, the probability is determined with respect to the preceding tag. Thus, the most probable tag for a word/phrase is based on the preceding tag (e.g., the most probable tag, given the tag on the previous word/phrase was XYX).

A variety of other tagging models and examples exist that may be used in conjunction with NLP processing. These include tagging by comparison to regular expressions as described herein, tagging in combination with rules, and other models. Any number of tagging approaches may be used in connection with the transaction documentation system.

Additionally or alternatively, prior to associating the metadata with the data element/word/phrase of the communication message the metadata is presented to the user for confirmation or editing. For example, the user may accept the suggested metadata, manually edit the suggested metadata, or reject the suggestions. In another example embodiment, users may manually annotate or tag data element/word/phrase of the communication message.

In an example embodiment, transaction documentation system 40 processes a newly-transmitted/posted communication message with the invocation of RegEx scripts to identify the transaction intent-bearing portions (e.g., data elements having transaction intent) of the communication message, and thereby explicitly identity the information found therein. The data elements having transaction intent are then tagged by analyzing the data elements of the communication message to identify matches with existing metadata tags from database 50. Additionally or alternatively, the transaction documentation system generates the metadata tags for the one or more data elements. In some embodiments, the data elements and metadata are stored in database 50 and used for transaction intent modeling. A user may optionally rate and/or edit the generated tags to which the transaction documentation system adjusts the generated tags based on the user rating and/or edits. The transaction documentation system is further configured to update a transaction intent model and transaction documentation corpus based on the user rating and/or edits.

In an example embodiment, the transaction documentation system 40 is configured to add the tag “agreement” to a particular communication message. In this example, “agreement” is a term of usage that may also be used as a keyword in a search of the communications repository for the transaction documentation system. However, if it is determined to not add a tag and that the communication message does not indicate purchase intent, then a determination is made whether to archive the communication stream. In another embodiment, the tag is extensible and additional information may be added to the tag by the transaction documentation system 40 as more communication messages are received. In another embodiment, the tag is cross-referenced to additional information stored in a database in order to determine whether to update the tag, archive the communication stream, and/or update the transaction intent state. It will be appreciated that many such approaches are possible.

Once “tagged” with such metadata, the tagged data elements of the communication message can be searched by the transaction documentation system 40 and used to populate the Tillable fields of the transaction document. It is the metadata definition that ends up determining how the communication messages will be logically organized, and how it can be accessed for the purposes of querying and managing. As used herein, a tag refers to metadata, such as a keyword or term of usage, associated with transaction intent information likewise associated with a user or entity.

The transaction documentation system 40 is configured to utilize the metadata to populate the transaction document for verification and execution by the user. This population reduces the amount of manual data entry, and improves the accuracy and speed of the transaction. In one embodiment, verification and execution of the dynamically modifiable transaction document may be processed through use of the marketplace platform configured to receive and display the document from the transaction documentation system. A user may access and view the document, verify the populated information, and enter any additional information that is needed to complete the transaction. The user may then submit the transaction to the marketplace platform.

C. Artificial Intelligence Configured Transaction Intent Models

The transaction documentation system 40 of certain embodiments is configured to determine the user's predicted likelihood to make a transaction based on the one or more communication messages associated with the user. For example, knowing that communication messages are tagged and/or identified as having transaction intent allows better estimation of the user's likelihood to finalize a transaction agreement over time. Forecasting of potential transaction agreements can be achieved in the artificial intelligence engine 47 of the transaction documentation system 40.

The transaction documentation system 40 may be configured to estimate the user's likelihood to move forward in transaction deal negotiations given a particular transaction intent state derived from one or more communication streams associated with the user. In some example embodiments, the transaction documentation system 40 estimates or forecasts the likelihood to make a transaction (e.g., agree to a transaction agreement deal) via one or more artificial intelligence and/or machine learning algorithms via the artificial intelligence engine 47. The artificial intelligence engine 47 may provide a plurality of algorithms for providing training data to the artificial intelligence algorithm. For example, in one approach, the training data may consist only of examples for formalized, agreed-upon (e.g., successful) transaction deal agreements and the machine learning model learns to predict the likelihood of success in a given scenario based on one or more communication streams. As an example, training data consists of both successful and unsuccessful transaction deal agreements and the model learns from both the positive and negative examples. Conversely, another approach may comprise building a model to predict a users' likelihood to formalize a transaction deal agreement or not formalize a transaction deal agreement given a purchase intent state derived from one or more communication messages.

In another example embodiment, the transaction documentation system 40 is configured to train, using the artificial intelligence engine 47, one or more models based on the metadata and associated data elements. The artificial intelligence engine 47 may implement various machine learning algorithms in which training data is provided consisting a large collection of communication messages that have been provided with metadata. Once the training data is provided, the artificial intelligence engine 47 is configured to identify data elements/words/phrases having transaction intent for population into a transaction document. An exemplary model training session may begin with an initial set of communication messages, and the artificial intelligence engine 47 may be given a list of data elements/words/phrases to search for in the communication messages data set. The artificial intelligence engine 47 may also be given a list of tags that are appropriate for those data elements/words/phrases. The artificial intelligence engine 47 thereby “learns” how to classify data by looking for a sequence of strings or patterns, then matching those sequence of strings or patterns to a tag. Thus, when training is complete, the artificial intelligence engine 47 can run the machine learning programs on other sets of communication messages. During these later training sessions, the artificial intelligence engine 47 will apply what it learned from the training and will search for and identify certain data elements/words/phrases in a communication stream and assign the appropriate tag. In an example embodiment the sequence of strings or patterns learned by the artificial intelligence engine 47 may be used to create and/or modify existing RegEx scripts.

D. Example Implementation

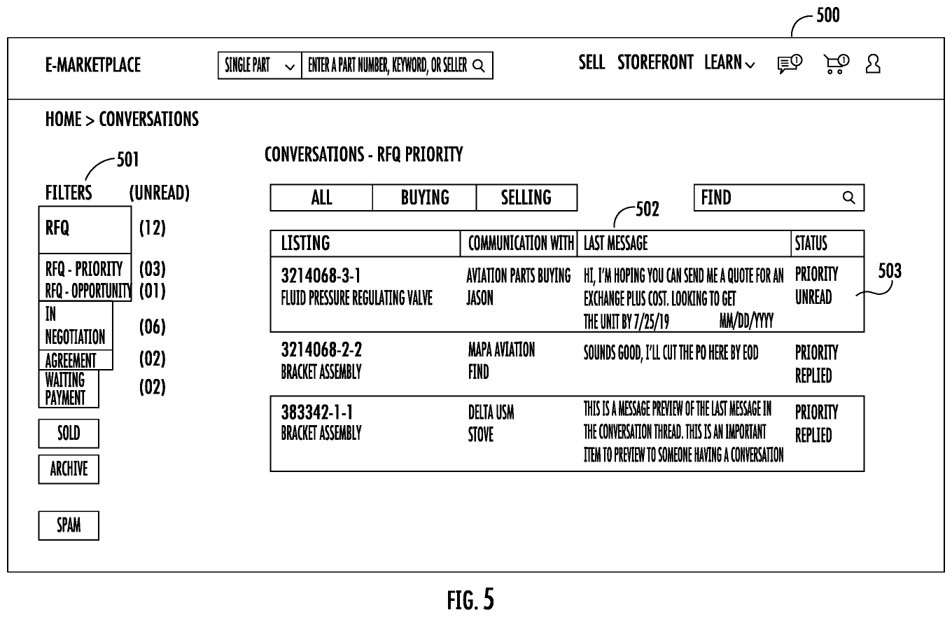

FIGS. 5, 6A, and 6B show example transaction documentation interfaces 54 (e.g., graphical user interfaces) that may be presented by one or more display screens of one or more computing devices for implementing an example configuration according to various embodiments. For example, the transaction documentation interfaces of 5, 6A, and 6B can be presented to a user by a client device 10 such as a desktop or laptop computer, or a mobile, handheld, or other client device. The depicted transaction documentation interfaces are configured to aid in facilitating execution of an enhanced deal negotiation workflow by quickly classifying potential deals and assist in the generation of transaction documents, such as transaction agreement, sale agreements, invoices, quotes and/or the like.

FIG. 5 illustrates a messages interface 500 returned by the transaction documentation application. The messages interface 500 includes at least two interactive sections. The two interactive sections include a transaction funnel element 501 and transactions messaging inbox 502. The transaction funnel element 501 refers to a portion of the messages interface 500 that is configured to support user interaction with a plurality of communication messages associated with a plurality of transactions associated with buying, selling, and/or trading products and services. In an example embodiment, transactions are ordered according to the transaction funnel element 501. In particular, the transaction funnel element 501 may include a number of ordered transaction intent states or categories. Each transaction may be assigned to a particular position in the transaction funnel element 501 based on the metadata of one or more communication messages associated with the transaction. In the illustrated example, a transaction for a fluid pressure regulating valve may be considered a RFQ high priority type because the fluid pressure regulating valve transaction includes a communication message comprising content requesting an exchange plus cost for by a specified date. A second transaction may be considered a RFQ opportunity type because the second transaction includes a communication message for a new RFQ requested by a known entity. The two transactions may be assigned to different positions in the transaction funnel element 501. By assigning these transactions to various positions within the transaction funnel element 501, a prioritization ordering for the transactions can be determined. The determined prioritization ordering for the transactions may be used to place or arrange the transactions and their associated communication streams on a web page as shown by messages interface 500. In using the prioritization ordering, the messages interface 500 enables presentation of transactions in a prioritized order that makes users more likely to engage with higher prioritized transactions with a likelihood of success.

The messages interface 500 also illustrates a transactions messaging inbox 502 comprising a plurality of transaction data elements. For example, FIG. 5 shows the transactions messaging inbox 502 comprising the transaction name (e.g., listing identifier), entity contact representative name (e.g., communicating with), the most recent communication message (e.g. last message), and purchase intent state (e.g., status). In an example embodiment, a user may select the transaction data elements related to the fluid pressure regulating valve transaction 503 for review. Upon selection of the fluid pressure regulating valve transaction 503, the transaction documentation system may be configured to generate for display the communication stream interface 600A as shown by FIG. 6A.

FIG. 6A illustrates operations related to deal negotiation workflow enhance actions for formalizing a deal and facilitating generation of a dynamically modifiable electronic transaction document (a transaction purchase agreement in the illustrated example) having fillable data fields populated with content from the one or more communications associated with the transaction. In an example embodiment, a user may access the communication stream interface 600A via selection of a transaction of the transactions messaging inbox 502. As shown in 6A, the communication stream interface 600A comprises a communication stream including one or more communication messages related to a particular transaction. In an example embodiment, the communication stream interface 600A includes transaction information 602A. The transaction information 602A identifies the particular transaction and includes the product identifier, product name, buyer/seller/owner name and company, condition of the product, and quantity of the product. In an example embodiment, the user may view the most recent communication messages received and sent. The communication stream interface 600A includes a most recent communication message 601A. The communication message 601A includes the following content “Hi, I'm hoping you can send me a quote for an exchange plus cost. Looking to get the unit by Jul. 25, 2019. Let Me Know, thanks!—Jason Aviation Parts Buying.” In response to receiving the communication message, the transaction documentation application may perform an authentication process configured to identify the user/sender of the communication message. In an example embodiment, the transaction documentation application is configured to determine whether the communication message is from a legitimate sender (e.g., sender email associated with a registered company, sender email associated with a private entity) or if it is likely that the address of the sender has been faked and the message is actually from a spammer. The transaction documentation application may be configured to utilize a variety of techniques to verify the domain name, IP address and e-mail address of the sender. For example, the domain name and IP address of an incoming message may be checked using domain key authentication (DK), domain keys identified mail validation (DKIM), a sender policy framework system (SPF), reverse DNS Lookup, and the like. If the communication message does not pass the authentication techniques indicating the communication message is from a spammer, then the communication message and the sender is blacklisted and classified as spam.

In circumstances when the communication message does pass the authentication techniques indicating the communication message is from a legitimate sender, the transaction documentation application may move forward with analyzing the sender's transaction history with the marketplace platform. In an example embodiment, the transaction documentation application is configured to access the transaction history of the user/sender. The transaction history may include data representing one or more successful transaction agreement deals and if previous attempts to transact were made. In some embodiments, to access the transaction history data associated with the user, the transaction documentation application is configured to retrieve the stored transaction history data from a database or other repository. The stored transaction history data may be retrieved based on the user identification information.

In an example embodiment, the transaction documentation application is configured to determine whether the sender has previously had a successful transaction with the message recipient. In circumstances when the sender has had one or more successful transactions with the message recipient in the past, the communication message may be classified as high priority because the confidence level associated with purchase intent is high. In circumstances when the sender has not had a successful transaction with the message recipient, the transaction documentation application is further configured to determine whether the sender has a history of one or more successful transaction agreement deals on the market platform despite not having a transaction history with the particular message recipient. In circumstances when the transaction documentation application determines that the sender has had one or more successful transaction agreement deals on the platform in the past, the communication message may be classified as new. In circumstances when the transaction documentation application determines that the sender has no successful transaction agreement deals on the platform based on the sender's transaction history, the transaction documentation application is further configured to determine whether the number of communication messages transmitted by the sender exceed a predetermined number of communication messages within a period of time. In circumstances when the number of communication messages transmitted by the sender exceed the predetermined number of communication messages within a period of time, the communication message is blacklisted and classified as spam. In circumstances when the number of communication messages do not exceed the predetermined number of communication messages within a period of time, the communication message is classified as new.

Concurrent or after the authentication process configured to identify the sender of the communication message as new (e.g., transaction intent—opportunity) or known (e.g., transaction intent—priority), the transaction documentation application is configured to analyze the message content by implementing regular expression script for identifying data elements (e.g., words and/or phrases) having purchase intent. For example and as shown in FIG. 6A, the transaction documentation application is configured to extract the content and metadata from communication message 601A using RegEx scripts. As depicted by 603B, but not actually shown on the communication stream interface 600A, the metadata extracted from communication message 601A includes RFQ (request for quote), requested ship date, and contact match. The transaction documentation application may then use the extracted content and metadata from communication message 601A to generate the dynamically modifiable electronic transaction document 605A and populate the one or more fillable fields of the document 605A with the extracted content (e.g. data elements) of the communication message 601A using metadata 603A. In another example embodiment, the communication stream interface 600A may provide the recipient of the communication message 601A with the option to send a communication message 604A in response to the communication message 601A.

The result of processing communication message 601A using the RegEx scripts is the following result:

Text: Hi, I'm hoping you can send me a quote for an exchange plus cost. Looking to get the unit
by 7/25/19. Let Me Know, thanks! - Jason Aviation Parts Buying
Metadata:
{

″id″: ″dafe8948ef379e6aef78cc1b059122cebcae436d7dd878375f16094a99a9243b″,
″name″: ″communication_message6094a99a9243b_1.msg″,

″last_updated″: ″2019-09-23T20:10:31.653Z″,

″meta″: {

″Desc″: ″Fluid Pressure Regulating Valve″,
″Author″: ″Jason″,
″RFQ″: ″send me a quote″,

```
  ″Requested Ship Date″: ″7/25/19″
  “Contact match”: [“known contact”, “Jason Aviation Parts Buying”, “priority”]
}
```

FIG. 6B depicts communication stream interface 600B having the newly transmitted communication message 601B as part of the communication stream for the fluid pressure regulating valve transaction. In response to receiving the communication message 601B, the transaction documentation application is configured to extract the content and metadata from communication message 601B using RegEx scripts. As depicted by 602B, but not actually shown on the communication stream interface 600B, the metadata extracted from communication message 601B includes price quote and ship date. The transaction documentation application may then use the extracted content and metadata from communication message 601B to generate the dynamically modifiable electronic transaction document 602B and populate the one or more fillable fields of the document 602B with the extracted content (e.g. data elements) of the communication message 601B using metadata 603B.

### V. Conclusion

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A transaction documentation system operable in association with a marketplace platform, the transaction documentation system comprising:
at least one processor; and
at least one memory including computer program code for one or more programs,
the at least one memory and the computer program code configured to, with the at least one processor, cause the system to perform at least the following:
receive a communication stream comprising a plurality of messages shared via the marketplace platform;
analyze the plurality of messages of the communication stream to detect a transaction intent;
retrieve a document based at least in part on the detected transaction intent, wherein the document comprises one or more fillable fields tagged with a required data element;
identify, within one or more messages of the communication stream, data elements corresponding to the one or more fillable fields of the document;
populate the one or more fillable fields of the document with data elements identified within the one or more messages of the communication stream; and
store the document comprising or more populated fillable fields in association with the communication stream in at least one data structure.

2. The transaction documentation system of claim 1, further comprising:
extracting the data elements and metadata from the one or more messages of the communication stream using regular expression scripts.

3. The transaction documentation system of claim 2, further comprising:
analyzing a training corpus of metadata tagged message communications using the regular expression scripts to identify the data elements indicative of transaction intent; and
building a transaction intent model by passing the data elements indicative of transaction intent and associated metadata to a machine-learning model.

4. The transaction documentation system of claim 3, further comprising:
classifying the transaction intent based on the metadata, a context of an entity associated with the communication stream, and the transaction intent model.

5. The transaction documentation system of claim 4, wherein the context of the entity associated with the communication stream comprises a profile of the entity, a transaction history of the entity with the marketplace platform, and interaction of the entity with other entities in the marketplace platform, and a determined authorization status of the entity.

6. The transaction documentation system of claim 1, further comprising:
updating the one or more fillable fields in response to receiving the communication stream comprising another plurality of messages shared via the marketplace platform.

7. The transaction documentation system of claim 1, further comprising:
determining a classification with which to associate the communication stream by utilizing a classification system comprising a first classification, a second classification, and a third classification;
archiving the communication stream when the communication stream is classified into the first classification;
updating the transaction intent when the communication stream is classified into the second classification; and
generating the document when the communication stream is classified into the third classification.

8. A method implemented by a transaction documentation system operable in association with a marketplace platform, the method comprising:
receiving a communication stream comprising a plurality of messages shared via the marketplace platform;
analyzing the plurality of messages of the communication stream to detect a transaction intent;
retrieving a document based at least in part on the detected transaction intent, wherein the document comprises one or more fillable fields tagged with a required data element;
identifying, within one or more messages of the communication stream, data elements corresponding to the one or more fillable fields of the document;
populating the one or more fillable fields of the document with data elements identified within the one or more messages of the communication stream; and
storing the document comprising or more populated fillable fields in association with the communication stream in at least one data structure.

9. The method of claim 8, further comprising:
extracting the data elements and metadata from the one or more messages of the communication stream using regular expression scripts.

10. The method claim 9, further comprising:
analyzing a training corpus of metadata tagged message communications using the regular expression scripts to identify the data elements indicative of transaction intent; and
building a transaction intent model by passing the data elements indicative of transaction intent and associated metadata to a machine-learning model.

11. The method of claim 10, further comprising:
classifying the transaction intent based on the metadata, a context of an entity associated with the communication stream, and the transaction intent model.

12. The method claim 11, wherein the context of the entity associated with the communication stream comprises a profile of the entity, a transaction history of the entity with the marketplace platform, and interaction of the entity with other entities in the marketplace platform, and a determined authorization status of the entity.

13. The method of claim 8, further comprising:
updating the one or more fillable fields in response to receiving the communication stream comprising another plurality of messages shared via the marketplace platform.

14. The method of claim 8, further comprising:
determining a classification with which to associate the communication stream by utilizing a classification system comprising a first classification, a second classification, and a third classification;
archiving the communication stream when the communication stream is classified into the first classification;
updating the transaction intent when the communication stream is classified into the second classification; and
generating the document when the communication stream is classified into the third classification.

15. A computer program product of a transaction documentation system operable in association with a marketplace platform, the computer program product comprising at least one non-transitory computer-readable medium having computer-readable program instructions stored therein, the computer-readable program instructions comprising instructions, which when performed by an apparatus, are configured to cause the apparatus to at least perform:
receiving a communication stream comprising a plurality of messages shared via the marketplace platform;
analyzing the plurality of messages of the communication stream to detect a transaction intent;
retrieving a document based at least in part on the detected transaction intent, wherein the document comprises one or more fillable fields tagged with a required data element;
identifying, within one or more messages of the communication stream, data elements corresponding to the one or more fillable fields of the document;
populating the one or more fillable fields of the document with data elements identified within the one or more messages of the communication stream; and
storing the document comprising or more populated fillable fields in association with the communication stream in at least one data structure.

16. The computer program product of claim 15, further comprising:
extracting the data elements and metadata from the one or more messages of the communication stream using regular expression scripts.

17. The computer program product of claim 16, further comprising:
analyzing a training corpus of metadata tagged message communications using the regular expression scripts to identify the data elements indicative of transaction intent; and
building a transaction intent model by passing the data elements indicative of transaction intent and associated metadata to a machine-learning model.

18. The computer program product of claim 17, further comprising:
classifying the transaction intent based on the metadata, a context of an entity associated with the communication stream, and the transaction intent model.

19. The computer program product claim 18, wherein the context of the entity associated with the communication stream comprises a profile of the entity, a transaction history of the entity with the marketplace platform, and interaction of the entity with other entities in the marketplace platform, and a determined authorization status of the entity.

20. The computer program product of claim 15, further comprising:
updating the one or more fillable fields in response to receiving the communication stream comprising another plurality of messages shared via the marketplace platform.
